(19) United States
(12) Patent Application Publication
(10) Pub. No.: US 2023/0034826 A1
(43) Pub. Date: Feb. 2, 2023

(54) SLOT MACHINE CARD GAME

(71) Applicant: OLIVANO GAMING CREATIONS INC., Commack, NY (US)

(72) Inventor: Anthony R. OLIVA, Farmingdale, NY (US)

(73) Assignee: OLIVANO GAMING CREATIONS INC., Commack, NY (US)

(21) Appl. No.: 17/876,092

(22) Filed: Jul. 28, 2022

Related U.S. Application Data
(60) Provisional application No. 63/226,463, filed on Jul. 28, 2021.

(51) Int. Cl. G07F 17/32

(52) U.S. Cl. CPC G07F 17/3293; G07F 17/3258; G07F 17/3209; G07F 17/3262; G07F 17/3267

(57) ABSTRACT

There is a slot machine for conducting a slot machine game comprising a data processor operable to conduct following step including presenting a card face down as representative of a dealer's card, allowing a user to selectively bet on a particular card held by the dealer, allowing a user to selectively bet that their future card to be drawn is a certain number, drawing a card for a user in a face up manner, allowing a user to bet that their card is higher than the dealer's card, allowing a user to bet additionally that their card is of a higher value than the dealer's card, revealing the dealer's card and settling all bets.

### CROSS REFERENCE TO RELATED APPLICATIONS

This application is a non-provisional application which claims priority to provisional application Ser. No. 63/226,463, filed on Jul. 28, 2021 the disclosure of which is hereby incorporated herein by reference.

### BACKGROUND OF THE INVENTION

At least one embodiment of the invention relates to a slot machine card game which comprises a gaming screen which has at least one or a series of cards presented therein. The user can then place a bet based upon the single card draw for both the user and the dealer.

### SUMMARY

There is a slot machine for conducting a slot machine game comprising a data processor operable to conduct following step including presenting a card face down as representative of a dealer's card, allowing a user to selectively bet on a particular card held by the dealer, allowing a user to selectively bet that their future card to be drawn is a certain number, drawing a card for a user in a face up manner, allowing a user to bet that their card is higher than the dealer's card, allowing a user to bet additionally that their card is of a higher value than the dealer's card, revealing the dealer's card and settling all bets.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1 is a layout for a screen for a slot machine;

FIG. 2 is a layout of a section of the screen for FIG. 1;

FIG. 3 is a schematic block diagram of the electronic components of the slot machine;

FIG. 4 is a flow chart for a first process that the slot machine uses;
FIG. 5 is a flow chart for a second process that the slot machine uses; and

FIG. 6 is a flow chart for another process for the slot machine.

### DETAILED DESCRIPTION

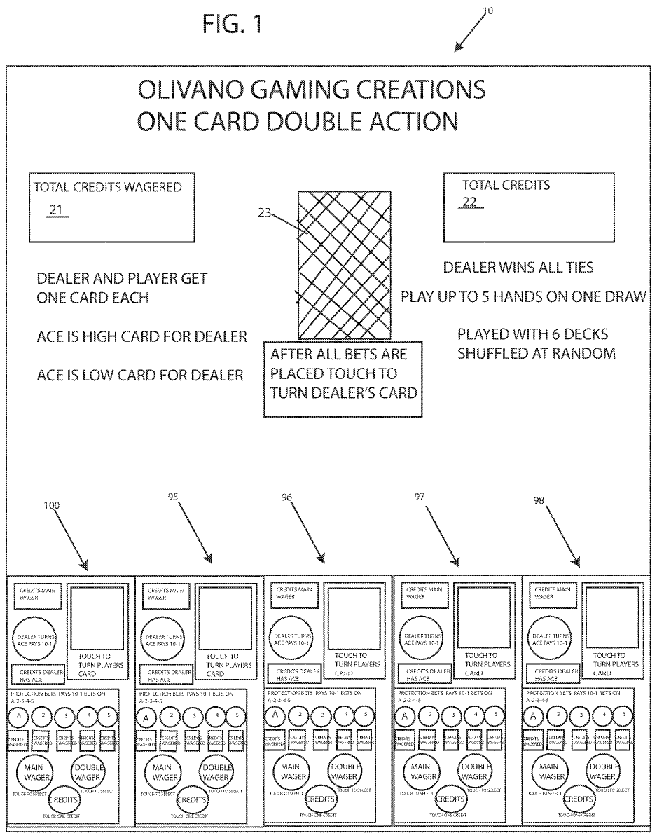

Referring in detail to the drawings, FIG. 1 is a layout for a screen for a slot machine. The screen 10 includes a first area 21 which indicates the total credits wagered for a player. Next there is an area 23, which is for the placement of a card face down, this is the dealer's card. Another area indicates the total credits 22 that the player has as well. The screen has a print out of the rules which include the dealer and player rules. The rules are as follows: the dealer and the player each get one card. The cards are first dealt face down. The player can select as many cards up to five different hands as shown in playing areas 95, 96, 97, 98, and 100. Next, for each card that the player is dealt, the player can bet that the card beats the dealer's card. For the player's card to beat the dealer's card, the card must be a number higher than the dealer's card. A tie where the dealer's card is for example a 5 and the player's card is for example a 5, this results in the dealer's win. A result where the player is dealt a 6 and the dealer is dealt a 5 results in the player winning the hand and the amount bet in that area. A result where the player is dealt a 4 and the dealer is dealt for example a 5, this results in the dealer winning the hand. When the dealer is dealt an ace and the player is dealt an ace the dealer wins because for a dealer, the ace is a high card and for the player the ace is the low card. The full process for the game is shown in FIG. 4.

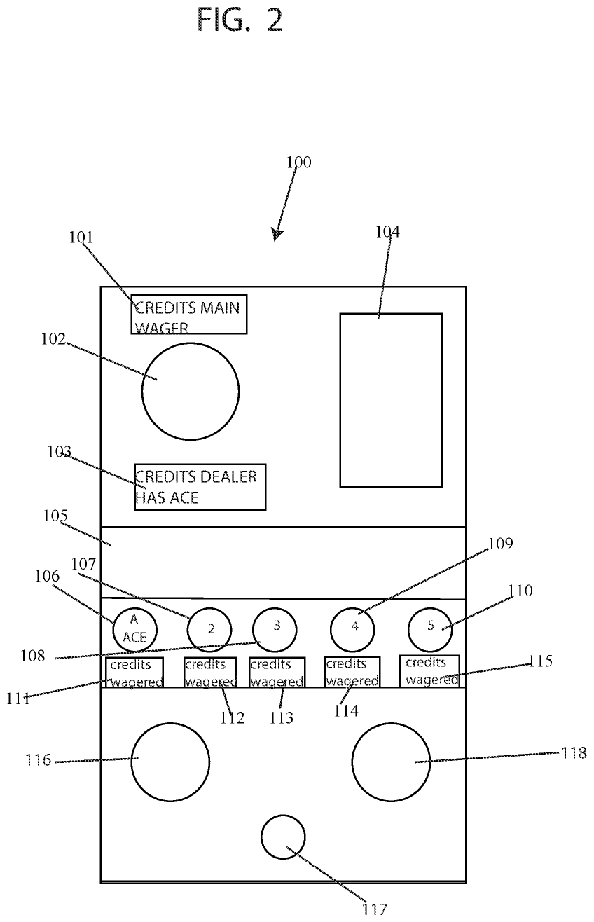

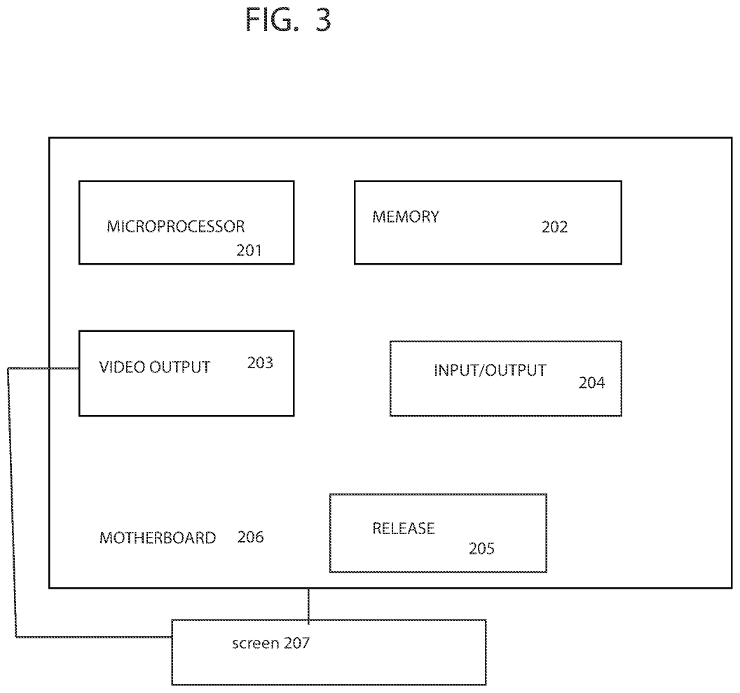

FIG. 2 is a layout of a section of the screen for FIG. 1. In this view, there is shown a user's betting section 100 which includes a set of controls for the user to make bets. Each betting section corresponds to a single playing area 95, 96, 98, 98, or 100. For example, there is an indicator which shows the number of credits for the main wager in section 101. Next, another section 102 is a betting button that the dealer has an ace. This button is to allow the user to bet via a form of insurance against the dealer having an ace. If the user presses this button, the system indicates in section 103 that there are a certain number of credits that are awarded to the user betting that the dealer has an ace. This number is bet on a round by round basis and is cleared out at the end of each round (a round is when all cards are revealed and the bets are paid out).

Another area 104 is the area where the user card is placed face down and then eventually revealed. Positioned below this position is a section 105 wherein this area includes an inscription area which lays out the rules for each of the users. In this area the rules state the following:

Player can make a protection bet on the A, 2, 3, 4, or 5. Protection bets must be placed before the player draws a card. Protection Bets Pays 10 to 1.

Below section 105 are a plurality of buttons which include the buttons for making these protection bets. For example, there is a button for betting on an Ace 106, a button for betting on a 2 card 107, a button for betting on a 3 card 108, a button for betting on a 4 card 109, and a button for betting on a five card 110. Underneath each of these buttons are indicators which indicate how many of these protection bets are placed. For example, there is a screen 111 for indicating how many credits are wagered for protection against an ace. Next, there is a screen 112 for indicating how many credits are wagered for protection against a 2. Next, there is a screen 113 for indicating how many credits are wagered for protection against a 3. Next, there is a screen 114 for indicating how many credits are wagered for protection against a 4. Next, there is a screen 115 for indicating how many credits are wagered for protection against a 5. In addition, there are also additional buttons in this area such as a button 116 for making a main wager. In addition, there is also a button 118 for making a main wager. In addition, there is another button 117 for adding credits to the main wager. In addition, there is also another group of buttons 120, 121, 122, 123 and 124 which are configured to allow the users to place multi amount wagers. For example, buttons 120, 121, 122, 123 and 124 can stand for amounts $1, $2, $3, $4, and $5 respectively. Alternatively, these buttons can stand for $1, $5, $10, $20, and $50. Alternatively, these buttons 120, 121, 122, 123 and 124 can stand for $5, $10, $20, $50 and $100 bets respectively. Thus, the user can place these bets using these buttons and then lock in these wagers so that once the round starts, these wagers can be used to bet against the house.

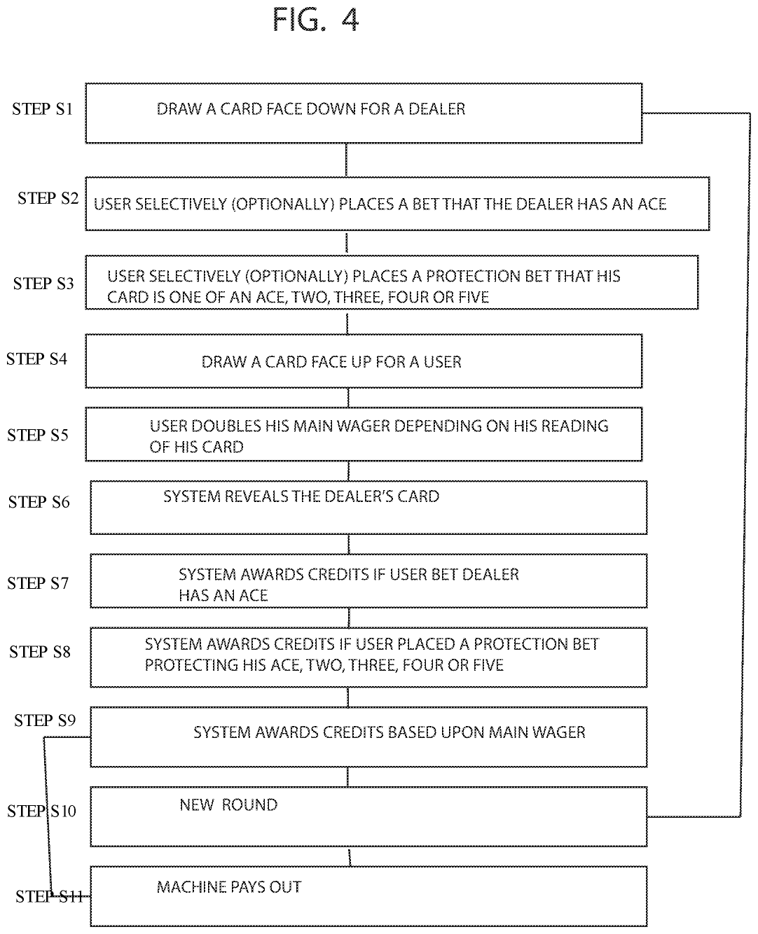

FIG. 3 is a schematic block diagram of the electronic components of the slot machine. For example, there is shown a motherboard 206 which has coupled to it a microprocessor 201, a memory 202, a video output 203, an input/output port such as a port for a keyboard (either tactile keyboard on the screen) or a keyboard of actual keys, there is also a screen 207, and a release 205 which serves as a release for money from the slot machine. The microprocessor is configured to carry out the steps shown in FIG. 4 on the machine shown in FIGS. 1 and 2.

FIG. 4 is a flow chart for the process that the slot machine uses. For example, in step S1 the machine proceeds to draw a card face down for the dealer. Next, in step S2, the machine selectively (optionally) allows for the placement of a bet by the user that the dealer has an ace. In this case, the user presses the button 102. Next, in step S3 the user selectively or optionally places a bet that the player has one of an ace, two three, four or five card. This can be performed by pressing any one of buttons 106 for Ace, 107 for 2, 108 for 3, 109 for 4, and 110 for 5. This protection bet is a bet against the player being dealt such a low card that the card would likely result in a loss of a hand. Next, in step S4 the system draws a card for the user face up. This card is placed in area 104. The user can then request that the card be positioned face up by tapping in area 104. Thus for each card dealt such as in areas 95, 96, 97, 98 or 100, the user/player taps location 104 for a dealing of the card.

Next, in step S5 the user has the option to double his/her main wager depending on the reading of his card. At this stage or even at an earlier step such as any time after step S1, the user can select to have multiple hands played against the dealer. That is why there are multiple hands shown as hands 95, 96, 97 98, and 100 on FIG. 1. Thus, the process can repeat itself numerous times in steps S2-S5 until all hands are set by the individual user.

Next, in step S6 the system reveals the dealer's card. This occurs when the player selects to turn the card over by tapping on area 23 where the dealer's card resides face down. Before this point additional cards across playing areas 95, 96, 97, 98, or 100 may be dealt. However once the user taps area 23 (See FIG. 1) then the round is initiated and no more cards may be dealt until the round is over.

Next, in step S7, if the system reveals that the dealer had an ace and the player purchased a bet or insurance that the dealer had an ace, the system awards the player if the user bet that the dealer had an ace. These credits would be placed in area 22 which indicates the total credits that are available to the user.

Next, in step S8, the system awards credits to the user if the user placed a protection bet protecting his ace, two, three, four or five hand. Next, in step S9, the system awards credits based upon the main wager. The process can jump to step S11 or, next, in step S10 the system initiates a new round, where the process returns to step S1. Next, in step S11 the machine pays out based upon the available credits awarded to the player. For each step it would be performed by the user interacting with a screen such as the screen shown in FIGS. 1 and 2 to send instructions or signals to a processor such as microprocessor 201 shown in FIG. 3. Microprocessor 201 would then pull instructions in the form of a programmatic instruction from memory 202 and also store scores and data in memory 202 as well so that the game can proceed through the steps shown in FIG. 4.

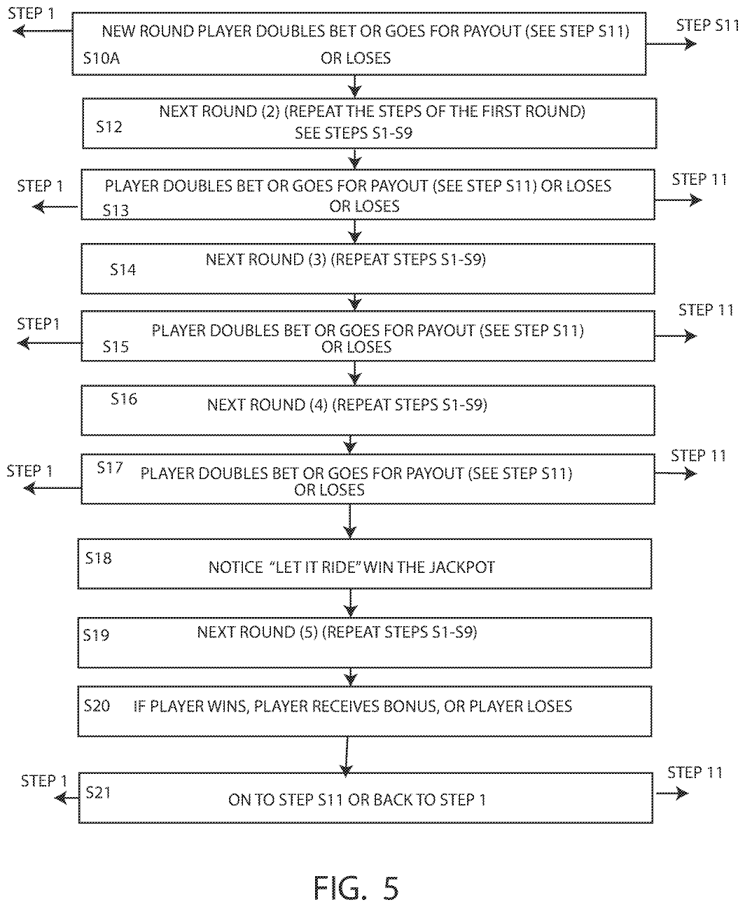

In another embodiment, such as shown in FIG. 5, the user can go for a bonus round wherein the user proceeds to step S10A wherein with a new round after winning the first round the player doubles their bet, goes for a payout (see step S11) or loses the initial wager. If the user has won the initial bet and wishes to press their bet or double down on their bet by wagering their winnings, the user proceeds to step S12 wherein the user plays again the steps in steps S1-S9. Next, in step S13 the if the player wins, the player can double down on their bet by pressing the winnings towards another round by proceeding to step S14. Alternatively, the user can cash out their winnings by proceeding to step S11. Or, alternatively, if the user loses the round the user can proceed back to step 1.

If the user reaches step S14 during the next round the user repeats steps S1-9. In step S15 the player doubles the bet or goes for the payout as shown in step S11. Alternatively, if the player loses then the player goes back to step 1. If the player wins the process goes to step S16 wherein the process proceeds to steps S1-59 again. Next, in step S17 the player doubles their bet or goes for the payout in step S11, or loses and proceeds back to step S1. At this point of the player has won and presses their bet, they get a notice to let it ride so that they can win the jackpot after five rounds of pressing their bets. The jackpot can represent an extra enhanced bonus such as an additional payout on a 2:1 margin, a 10:1 margin or a 1.5:1 margin or any suitable margin that would enhance an initial win. Next, in step S19 the process proceeds back to steps S1-S9 where the player places additional bets. Next, in step S20 if the player wins the player receives the bonus. Alternatively, if the player loses the process proceeds back to step S1. If the player wins the jackpot then the process proceeds back to step S11 wherein the player can receive the payout.

In monetary terms if the player wins for example $10.00 in the first round, the players pot would have been doubled from the initial bet of $10.00 so that the total pot after the first round would be $20.00 at step 10A. Next round the if the player wishes to repeat the steps of steps S1-S9 the player wins again in round 2, then the pot would have grown to $40.00. Next, if the player presses their bet in round 3, (step 14), and wins (See step 15), then the pot would have grown to $80.00. Next, if the user would press their bet, and they would proceed to round 4 and they win that bet they would have a total pot of $160.00 by step S17. Next, in step S18 they would have the notice that they could win the jackpot. Normally if the player wins through round 5 the total winnings would be $320.00. However, with the jackpot, these are enhanced winnings, wherein the total winnings are enhanced by an additional multiplier such as by 1.5, 2. Or 10 for example. If the multiplier or enhanced winning margin is 2, then the total enhanced jackpot would be $640.00. However, if the winnings was only enhanced by 1.5 (enhanced winning margin) then the total jackpot would be 480. Alternatively, if the total enhancement was by a factor of 10 (enhanced winning margin), then the total winnings would be $3200.00. Thus, with these rounds of jackpots, the user has the benefit of pressing their winnings towards an enhanced jackpot to enhance their chance of winning. All of these steps are performed using microprocessor 201, which provides these options to the user.

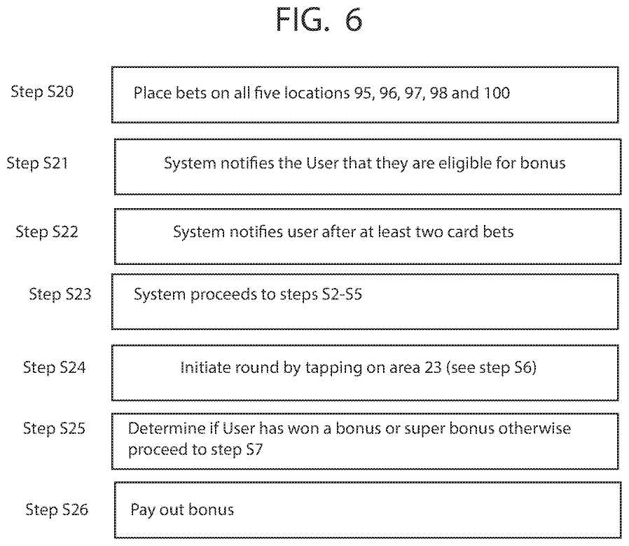

FIG. 6 is a process for another means for a jackpot. With this design, the player has the option to go for a jackpot in a single round. Therefore, in step S20, the user can place bets on five different locations in a single round such as betting on all five cards in areas 95, 96, 97, 98 and 100. Thus, in step S20, if the user bets on all five cards, the process proceeds to step S21, wherein the system notifies the user that they are eligible for a bonus round. In an alternative embodiment, the process can proceed to step S22 wherein the system informs the player after the player places a bet on a second card location such as on card 107, that they are eligible for a bonus if they bet on all five cards. This information occurs by processor 201 sending a signal to notify the user on the screen such as screen 207 which displays the displays shown in FIGS. 1 and 2. Next, in step S23 the user can proceed to place protection bets or alternative bets as indicated above (see steps S2-S5), and then proceed to step S24 wherein the user initiates the round by tapping on area 23 (See step S6). If the user placed bets on all five areas, and those areas are set, then the user is eligible for the bonus. Thus, in step S25, the system (microprocessor 201) determines whether the cards dealt to the user make the user eligible for a bonus. In at least one embodiment, the bonus is met if the user has a straight hand of cards such as five consecutive cards such as cards 2, 3, 4, 5, 6, or cards 7, 8, 9, 10, Jack (in any order) in areas 95, 96, 97, 98 and 100. Alternatively, if the user has a straight hand in order (ascending in areas 95, 96, 97, 98, and 100) then the bonus is met as well. In this case, the bonus could be an even higher payout. Alternatively, the bonus could be paid if the cards are all of the same suit such as all clubs, or all hearts, or all spades or all diamonds. If all five of these cards meet this bonus criteria in a single round then a bonus is paid out in step S26. If the user does not achieve the bonus, the system can still pay out based upon the rules and process presented in FIG. 4 outlined above for each card. The different payouts on the bonus could be on a 2:1 payout, a 1.5:1 additional bonus payout, a 5:1 additional payout, 10:1 bonus payout, a 50:1 bonus payout for each of these conditions depending on either a random decision by microprocessor 201, an amount of time that the player has played or based upon the closest fairest determination of the winning percentage which may favor the house over the player. Thus, the process of FIG. 4 can be augmented and made more exciting by having different types of bonus rounds for the user/player.

Accordingly, while at least one embodiment of the present invention have been shown and described, it is to be understood that many changes and modifications may be made thereunto without departing from the spirit and scope of the invention as defined in the appended claims.

What is claimed is:

1. A slot machine for conducting a slot machine game comprising a data processor operable to conduct the following steps:
a) placing at least one main wager
b) placing at least one insurance bet;
c) placing an optional additional main wager on at least one additional hand;
d) placing an additional protection bet on each hand;
e) starting dealing cards on a screen of a slot machine;
f) dealing at least one card to a player face up for each main wager;
g) dealing at least one card to a dealer face down;
h) determining whether a player wins an initial bet;
i) placing via a player an Ace Insurance bet;
j) placing a double wager bet
k) pressing start to reveal a dealer's card
l) revealing a dealers card;
m) paying out on all bets.

2. The slot machine as in claim 1, wherein the processor is configured to credit the user's account on the settlement of all bets.

3. The slot machine as in claim 1, wherein the processor is configured to release monetary units on the settlement of all bets.

4. The slot machine as in claim 1, further comprising a screen wherein the screen is configured to show the dealer's card and the user's card.

5. The slot machine as in claim 4, wherein the screen is a touch screen.

6. The slot machine as in claim 1, wherein the processor is a microprocessor.

7. The slot machine as in claim 5, wherein the touch screen has a first set of pixels configured as a bet button, such that when the user wishes to place a bet that their card is higher than the dealer's card the users presses said first set of pixels the user places a bet that their card is of higher value than the dealer's card.

8. The slot machine as in claim 6, wherein the microprocessor is configured to perform the following steps:
provide an option to the player to automatically play their winnings and to repeat steps e-m;
determining whether the player has won this second round or lost this second round;
providing the player if the player has won the second round the option to take their winnings or to press their winnings to another round;
paying out the player's winnings or, allowing the user to press these winnings to another round wherein the microprocessor automatically plays these winnings and repeats steps e-m.

9. The slot machine as in claim 8, wherein if the user plays at least three consecutive rounds and wins each round the microprocessor indicates that the player is eligible for a jackpot.

10. The slot machine as in claim 8, wherein if the user plays at least four consecutive rounds and wins each round the microprocessor indicates that the player is eligible for a jackpot.

11. The slot machine as in claim 10, wherein if the player wins at least five consecutive rounds, the microprocessor pays a jackpot to the player comprising an enhanced winning margin.

12. The slot machine as in claim 11, wherein the enhanced winning margin is a 2:1 winning margin.

13. The slot machine as in claim 11, wherein the enhanced winning margin is a 1.5:1 margin.

14. The slot machine as in claim 11, wherein the enhanced winning margin is a 10:1 margin.
